(19) United States
(12) Patent Application Publication
(10) Pub. No.: US 2004/0052912 A1
(43) Pub. Date: Mar. 18, 2004

(54) Five-layered, biaxially-oriented tubular film for packaging and wrapping of meat or meat with bones and use thereof

(76) Inventors: Hartmut Grund, Otterstadt (DE); Horst Lang, Weinheim (DE); Helmut Schauer, Mannheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/466,774

(22) PCT Filed: Feb. 1, 2001
(86) PCT No.: PCT/EP01/01067

(51) Int. Cl. A23B 4/00

(52) U.S. Cl. 426/125

(57) ABSTRACT

The invention relates to a five-layered, biaxially oriented, shrinkable and sealable tubular film for the packaging and wrapping of meat or meat with bones and to the use thereof. The tubular film of the invention has an inner layer comprised of at least one heat-sealable copolyamide, a polyolefin middle layer, and an outer layer comprised of at least one homopolyamide, and two adhesion-promoting layers between the inner layer and middle layer and between the middle layer and outer layer. Such tubular films are remarkable for their superior seal seam strength and high resistance to puncturing.

The invention relates to a five-layered, biaxially oriented, shrinkable, sealable tubular film and to its use for the packaging and wrapping of meat or meat with bones.

A five-layered, polyamide-based tubular film for packaging and wrapping pasty foodstuffs, especially a sausage skin, is already known from DE 43 39 337 C2. This tubular film is comprised of an inner layer and an outer layer made of the same polyamide material, a middle polyolefin layer and two adhesion-promoting layers made of the same material and situated between the inner layer and middle layer and between the middle layer and outer layer. The inner and outer layers consist of at least one aliphatic polyamide and/or at least one aliphatic copolyamide and at least one partially aromatic polyamide and/or at least one partially aromatic copolyamide, the amount of partially aromatic polyamide and/or copolyamide being from 5 to 60 wt.-%, relative to the total weight of the polymer mixture of partially aromatic and aliphatic polyamides and copolyamides. Such a tubular film, produced by coextrusion, is provided with controlled shrinkability by biaxial stretching and heat-setting. With respect to its technological properties important to wrapping and packaging of meat, especially meat with bones, such a tubular film requires some improvements. In the event of meat with bones there is a risk of protruding bones piercing the packaging film following shrinking of the packaging film on the packaged item, because the puncture resistance is insufficient. Furthermore, such tubular films for packaging and wrapping meat or meat with bones should also allow sealing by simple heat-sealing. With bags produced using such tubular films, the strength of the seal seam is a crucial issue. The heat-seal seam is exposed to extreme load both during packaging of the pieces of meat and in the subsequent vacuum treatment and shrinking of the bags. Likewise, shipment and storage of the filled bags involve high demands on the puncture resistance of the film and on the seal seam strength.

The object of the present invention is therefore to provide a biaxially oriented, shrinkable, sealable tubular film for the packaging and wrapping of meat or meat with bones which, in addition to the requirements to be met by such a packaging film, such as low water vapor and oxygen permeabilities, firstly has high puncture resistance of the tubular film and secondly high strength of the seal seam.

According to the invention, said object is accomplished by means of a five-layered, biaxially oriented, shrinkable, sealable tubular film having the characterizing features of claim 1.

The inner layer of the tubular film according to the invention is comprised of a heat-sealable copolyamide, preferably of copolyamide 6/12 and/or copolyamide 6/66. Suitable copolyamides are well-known and can be produced from appropriate monomers such as caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetramethylenediamine, pentamethylenediamine, hexamethylenediamine, octamethylenediamine, and xylylenediamine. The wall thickness of the inner layer is between 5 and 16 μm.

A polyolefin layer preferably constituted of homopolymers of ethylene or propylene and/or copolymers of linear α-olefins having from 2 to 8 C atoms is used as middle layer in the wrapping according to the invention. Linear low-density polyethylene, high-density polyethylene, polypropylene homopolymer, polypropylene block copolymer and polypropylene random copolymer are preferably used for the middle layer. The wall thickness wall of this layer is between 6 and 22 μm.

The two adhesion-promoting layers between the inner layer and middle layer on the one hand, and between the middle layer and outer layer on the other hand are preferably made of the same material, namely, of polyolefins modified with functional groups. Such modified polyolefins are modified homo- and copolymers of ethylene and/or propylene and optionally other linear α-olefins having from 3 to 8 C atoms which have monomers from the group of α,β-unsaturated dicarboxylic acids such as maleic acid, fumaric acid, itaconic acid, or anhydrides, esters, amides or imides thereof grafted thereon. The wall thickness wall of each adhesion-promoting layer is between 3 and 10 μm.

The outer layer consists of at least one homopolyamide, preferably an aliphatic homopolyamide. Aliphatic homopolyamides are homopoly-condensation products of aliphatic primary diamines and aliphatic dicarboxylic acids or homopolymers of ω-aminocarboxylic acids or lactams thereof. Examples of aliphatic diamines are tetra-, penta-, hexa- or octamethylenediamine. Suitable aliphatic dicarboxylic acids are adipic acid, azelaic acid, sebacic acid, decanedicarboxylic acid, dodecanedicarboxylic acid. The ω-aminocarboxylic acids or their lactams include from 6 to 12 C atoms. Examples are 11-aminoundecanoic acid, ε-caprolactam and ω-laurinlactam. The wall thickness wall of the outer layer is between 12 and 43 μm.

The tubular films of the invention are produced by coextrusion wherein the individual polymers for the separate layers are plastified and homogenized in five extruders, and the five melt streams, according to the desired single wall thickness ratios, are subsequently extruded through a five-layer extrusion head to form a primary tube and subjected to biaxial stretching and heat-setting.

In addition, well-known auxiliary agents such as anti-blocking agents, stabilizers, antistatic agents or lubricants can be included in the tubular film. These auxiliary agents are normally added in amounts of from 0.1 to 5 wt.-%. Furthermore, the film can be colored by adding pigments or pigment mixtures.

The tubular films of the invention have an overall wall thickness of from 30 to 100 μm, preferably from 50 to 90 μm.

Surprisingly, the tubular films of the invention are clearly superior to the tubular films of DE 43 39 337 C2 both with respect to seal seam strength and puncture resistance.

To determine the seal seam strength, each tubular film was welded inside at a right angle to the machine direction, using an SGPE 20 laboratory welding apparatus from W. Kopp Verpackungsmaschinen. Strips 25 mm in width were taken from the welded tubular films in such a way that the welding seam was at a right angle to the length of the strip. The strip samples were stretched on a tensile testing machine from Instron Company at a stretching rate of 500 mm/min until breaking of the weld seam occurred. The resulting maximum force will be referred to as seal seam strength herein-after.

As a measure for the puncture resistance, the damaging energy is determined in a penetration test.

The damaging energy was determined following DIN 53373, but deviating from said DIN standard, a hardened cylindrical form A pin 3 mm in diameter, according to DIN EN 28 734, was used as impact body and the testing rate was 500 mm/min. The damaging energy is the energy that is absorbed until initial tearing of the sample occurs.

The tubular film according to DE 43 39 337 C2 could not be welded at sealing temperatures of 140 and 180° C., while the tubular film of the invention has a satisfactory seal seam strength of 36 N/25 mm already at a sealing temperature of 140° C. and even achieves an excellent seal seam strength of 78 N/25 mm at a sealing temperature of 180° C. Even at a sealing temperature of 220° C., the tubular film according to DE 43 39 337 C2 shows an extremely unsatisfactory seal seam strength, while the tubular film of the invention exhibits a further increase in seal seam strength at this sealing temperature.

With the tubular film of the invention, the damaging energy is 530 mJ, while the tubular film according to DE 43 39 337 C2 achieves a damaging energy of not more than 410 mJ.

The invention will be illustrated in more detail with reference to the following example.

### EXAMPLE

The individual polymers for the separate layers were plastified and homogenized in five extruders. According to the desired single wall thickness ratios, the five melt streams were fed into a five-layer extrusion head, formed into a primary tube and subjected to biaxial stretching and heat-setting. The primary tube had a diameter of 62 mm and a mean overall wall thickness of 0.68 mm. It was heated to 110° C. using infrared radiation and stretched at a surface stretch ratio of 9.7. The biaxially stretched tube was heat-set, flattened, and wound up. The mean overall wall thickness of the tube was 70 μm, and the flat width was 328 mm.

The layers of the final tube consisted of the following polymers, with a single wall thickness as indicated:

| | |
|---|---|
| 1^{st} layer (outer layer): | Polyamide 6, Durethan B40 F from Bayer AG, |
| | 32 μm |
| 2^{nd} layer: | Adhesion promotor, modified polyethylene, |
| | Bynel 4140 from Du Pont de Nemours GmbH, |
| | 6 μm |
| 3^{rd} layer: | Polyethylene (LLDPE), Flexirene CL 10 from |
| | Polymeri Europa SRL, 15 μm |
| 4^{th} layer: | Adhesion promotor (as in layer 2), 6 μm |
| 5^{th} layer (inner layer): | Polyamide 6/12, Grilon CF6S from EMS Chemie, |
| | 11 μm |

The following seal seam strength values were determined:

| | |
|---|---|
| Sealing temperature 140° C.: | 36 N/25 mm |
| Sealing temperature 180° C.: | 78 N/25 mm |
| Sealing temperature 220° C.: | 83 N/25 mm |

The damaging energy was 530 mJ.

### COMPARATIVE EXAMPLE

A five-layered tubular film with the following structure was produced according to DE 43 39 337 C2:

| | |
|---|---|
| 1^{st} layer (outer layer): | Blend of 95% polyamide 6, Durethan B40 F from |
| | Bayer AG and 5% polyamide 6I/6T, Grivory G21 |
| | from EMS Chemie, 25 μm |
| 2^{nd} layer: | Adhesion promotor, modified polyethylene, |
| | Admer NF 478 E from Mitsui Chemicals Inc., |
| | 8 μm |
| 3^{rd} layer: | Polyethylene (LLDPE), Dowlex 2049 E from |
| | DOW Chemical Company, 21 μm |
| 4^{th} layer: | Adhesion promotor (as in layer 2), 8 μm |
| 5^{th} layer (inner layer): | Blend of 95% polyamide 6, Durethan B40 F from |
| | Bayer AG and 5% polyamide 6I/6T, Grivory G21 |
| | from EMS Chemie, 8 μm |

The following seal seam strength values were determined:

| | |
|---|---|
| Sealing temperature 140° C.: | no welding |
| Sealing temperature 180° C.: | no welding |
| Sealing temperature 220° C.: | 2 N/25 mm |

The damaging energy was 410 mJ.

1. A five-layered, biaxially oriented, shrinkable, sealable tubular film for the packaging and wrapping of meat or meat with bones, characterized in that the tubular film is constituted of an inner layer comprised of at least one heat-sealable copolyamide, a polyolefin middle layer, and an outer layer comprised of at least one homopolyamide, and two adhesion-promoting layers which preferably consist of the same material and are situated between the inner layer and middle layer and between the middle layer and outer layer.

2. The tubular film according to claim 1, characterized in that the inner layer is comprised of at least one copolyamide produced from monomers selected from the group of caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetramethylenediamine, pentamethylenediamine, hexamethylenediamine, octamethylenediamine, and xylylenediamine.

3. The tubular film according to claim 1, characterized in that the inner layer consists of polyamide 6/12 and/or polyamide 6/66.

4. The tubular film according to any of claims 1 to 3, characterized in that the polyolefin middle layer is constituted of homopolymers of ethylene or propylene and/or of copolymers of linear α-olefins having from 2 to 8 C atoms.

5. The tubular film according to claim 4, characterized in that the polyolefins of the middle layer are preferably comprised of linear low-density polyethylene, high-density polyethylene, polypropylene homopolymers, polypropylene block copolymers and polypropylene random copolymers.

6. The tubular film according to any of claims 1 to 5, characterized in that the two adhesion-promoting layers are comprised of polyolefins modified with functional groups.

7. The tubular film according to claim 6, characterized in that the modified polyolefins are modified homo- or copolymers of ethylene and/or propylene and optionally other linear α-olefins having from 3 to 8 C atoms, which have monomers from the group of α,β-unsaturated dicarboxylic acids, preferably maleic acid, fumaric acid, itaconic acid, or anhydrides, esters, amides or imides thereof grafted thereon.

8. The tubular film according to claim 6, characterized in that the modified polyolefins of the two adhesion-promoting layers are copolymers of ethylene or propylene and optionally other linear α-olefins having from 3 to 8 C atoms and α,β-unsaturated carboxylic acids, preferably acrylic acid, methacrylic acid and/or metal salts and/or alkyl esters thereof, or appropriate graft copolymers of the above-mentioned monomers on polyolefins, or partially saponified ethylene-vinyl acetate copolymers which are optionally graft-polymerized with an α,β-unsaturated carboxylic acid and have a low saponification level, or mixtures thereof.

9. The tubular film according to any of claims 1 to 8, characterized in that the tubular film consists of a coextruded and biaxially stretched tubular film which has been subjected to heat-setting.

10. The tubular film according to any of claims 1 to 9, characterized in that the outer layer is constituted of a homopolyamide.

11. The tubular film according to claim 10, characterized in that the outer layer is constituted of an aliphatic homopolyamide.

12. The tubular film according to claim 11, characterized in that the aliphatic homopolyamide is formed from aliphatic primary diamines and aliphatic dicarboxylic acids or ω-aminocarboxylic acids or lactams thereof.

13. The tubular film according to claim 12, characterized in that the aliphatic homopolyamide is polyamide 6.

14. The tubular film according to any of claims 1 to 13, characterized in that the wall thickness thereof is from 30 to 100, preferably from 50 to 90 μm.

15. Use of the tubular film according to any of claims 1 to 14 for packaging meat or meat with bones.

16. A bag, characterized in that the bag is produced from a tubular film according to any of claims 1 to 14 by welding or sealing of the inner layer on itself.

17. Use of a bag produced according to claim 16 for packaging meat or meat with bones.
